(19) United States
(12) Patent Application Publication
(10) Pub. No.: US 2004/0006912 A1
(43) Pub. Date: Jan. 15, 2004

(54) Oxidation-stabilized oily liquids based on vegetable or animal oils

(75) Inventor: Matthias Krull, Harxheim (DE)

Correspondence Address: CLARIANT CORPORATION, INTELLECTUAL PROPERTY DEPARTMENT, 4000 MONROE ROAD, CHARLOTTE, NC, 28205, US

(73) Assignee: Clariant GmbH

(21) Appl. No.: 10/458,906

(22) Filed: Jun. 11, 2003

(30) Foreign Application Priority Data
Jul. 9, 2002 (DE) 10230771.7
Nov. 14, 2002 (DE) 10252972.8

(51) Int. Cl. C08K 5/10; C10L 1/18

(52) U.S. Cl. 44/385; 524/315

(57) ABSTRACT

The present invention provides oily liquids comprising

A) at least one ester of fatty acids whose carbon chain lengths are between 8 and 30 carbon atoms, and a monohydric C₁-C₅-alcohol, at least 50% of the fatty acid radicals containing at least one double bond, and

B) at least one alkylphenol-aldehyde resin, obtainable by condensing

(i) at least one alkylphenol having at least one C₆-C₂₄-alkyl or C₆-C₂₄-alkenyl radical and

(ii) at least one aldehyde or ketone

to a degree of condensation of between 2 and 50 alkylphenol units.

The present invention relates to oils which have improved oxidation stability and are composed of fatty acid esters and alkylphenol resins, and also to their use as fuel oils and to improve lubricity of desulfurized middle distillates.

In new of decreasing world oil reserves and the discussion about the environmentally damaging consequences of the consumption of fossil and mineral fuels, there is increasing interest in alternative energy sources based on renewable raw materials. These include in particular natural oils and fats of vegetable or animal origin. These are generally triglycerides of fatty acids having from 10 to 24 carbon atoms and a calorific value comparable to conventional fuel oils, but which at the same time are classified as biodegradable and environmentally compatible.

Oils obtained from animal or vegetable material are mainly metabolism products which include triglycerides of monocarboxylic acids, for example acids having from 10 to 25 carbon atoms and corresponding to the formula

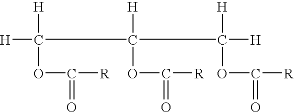

where R is an aliphatic radical which has from 10 to 25 carbon atoms and may be saturated or unsaturated.

In general, such oils comprise glycerides from a series of acids whose number and type vary with the source of the oil and they may additionally comprise phosphoglycerides. Such oils can be obtained by prior art processes.

As a consequence of the sometimes unsatisfactory physical properties of the triglycerides, the industry has applied itself to converting the naturally occurring triglycerides to fatty acid esters of lower alcohols such as methanol or ethanol.

In addition to the direct use as a fuel, fatty acid alkyl esters are also used as additives, for example for mineral oils and mineral oil distillates.

Fuel oils having a sulfur content reduced to less than 500 ppm in particular have such poor friction- and wear-reducing properties that lubricity additives have to be added to them. These are based, inter alia, on esters of unsaturated fatty acids with lower alcohols (biodiesel).

The oily liquids used industrially as fuel oils and additives are based mainly on oils from natural sources such as rapeseed, sunflowers, soya and similar oil seeds. These have a high proportion of unsaturated fatty acids of more than 50% and preferably of more than 80%, which confers acceptable rheological properties on them, especially under cold conditions.

For instance, EP-A-0635558 discloses the use of biodiesel based on C₁-C₅-alkyl esters of saturated and unsaturated, straight-chain C₁₂-C₂₂-fatty acids as lubricity improvers for gas oils having low sulfur and aromatics content.

EP-A-0935645 discloses the use of C₁-C₃₀-alkylphenol resins as lubricity additives for low-sulfur diesel. The examples relate to C₁₈- and C₂₄-alkylphenol resins.

WO-99/61562 discloses mixtures of alkylphenol resins, nitrogen compounds and ethylene copolymers as low temperature and lubricity additives for low-sulfur diesel.

DE-A-10111857 discloses esters of predominantly saturated unbranched fatty monoacids with mixtures of C₁-C₄-monoalcohols and methylated mono- and/or dihydroxybenzenes as an additive to sulfur-free mineral diesel fuel. Among other properties, the hydroxybenzenes improve the oxidation stability of the additives.

The oily liquids based on esters of unsaturated fatty acids, which are preferred over the esters based on saturated fatty acids as a consequence of their rheological properties, can resinify on prolonged storage, especially under elevated temperature, to give products having only limited oil solubility. This can lead to the formation of viscous separations and deposits in the storage container and also in the additized fuel oil. This can also lead to deposits in the engine, in particular at the valves and injection nozzles.

In addition, the effectiveness as lubricity additives of the fatty acid esters based on oil seeds, which are available from agricultural production in large amounts and inexpensively, is comparatively low. To achieve an effect which is sufficient in practice, high dosages of 1000 ppm and more are consequently required, which entails huge logistical demands.

It is therefore an object of the present invention to find fuel oils and additives which are based on unsaturated vegetable and animal oils and have an improved oxidation stability compared to the prior art and at the same time an improved effectiveness as a lubricity additive for reduced-sulfur mineral oils and mineral oil distillates.

It has been found that, surprisingly, combinations of esters of unsaturated fatty acids with alkylphenol-aldehyde resins have a distinctly improved oxidation stability. In addition, they exhibit a lubricity superior to the individual components in low-sulfur fuel oils.

The present invention therefore relates to oily liquids comprising

A) at least one ester of fatty acids whose carbon chain lengths are between 8 and 30 carbon atoms, and a monohydric C₁-C₅-alcohol, at least 50% of the fatty acid radicals containing at least one double bond, and

B) at least one alkylphenol-aldehyde resin, obtainable by condensing

(i) at least one alkylphenol having at least one C₆-C₂₄-alkyl or C₆-C₂₄-alkenyl and

(ii) at least one aldehyde or ketone

to a degree of condensation of between 2 and 50 alkylphenol units.

The above-defined oily liquids are also referred to hereinbelow as additives. The invention further relates to the use of the above-defined oily liquids as fuel oil.

The invention further provides fuel oils having a maximum sulfur content of 0.035% by weight and comprising the additives according to the invention.

The invention further relates to the use of the additives according to the invention for improving the lubricity of fuel oils having a sulfur content of at most 0.035% by weight.

The invention further relates to a process for improving the lubricity of fuel oils having a maximum sulfur content of 0.035% by weight by adding the additive according to the invention to the fuel oils.

Preferred fatty acids which are a constituent of the esters A) are those having from 10 to 26 carbon atoms, in particular from 12 to 22 carbon atoms. The alkyl radicals or alkenyl radicals of the fatty acids consist substantially of carbon and hydrogen. However, they can also bear further substituents, for example hydroxyl, halogen, amino or nitro groups, as long as these do not impair the predominant hydrocarbon character. The fatty acids preferably contain at least one double bond. They can contain a plurality of double bonds, for example 2 or 3 double bonds, and be of natural or synthetic origin. In the case of polyunsaturated carboxylic acids, their double bonds can be isolated or else conjugated. Preference is given to mixtures of two or more unsaturated fatty acids having from 10 to 26 carbon atoms. In particularly preferred fatty acid mixtures, at least 75% by weight, especially at least 90% by weight, of the fatty acids contain one or more double bonds. The iodine numbers of the parent fatty acids or fatty acid mixtures of the esters according to the invention are preferably above 50 g of l/100 g, more preferably between 100 and 190 g of l/100 g, in particular between 110 and 180 g of l/100 g and especially between 120 and 180 g of l/100 g, of fatty acid or fatty acid mixture.

Examples of suitable unsaturated fatty acids include oleic acid, erucic acid, palmitoleic acid, myristoleic acid, linoleic acid, linolenic acid, elaeosteric acid, arachidonic acid and/or ricinoleic acid. According to the invention, preference is given to using fatty acid mixtures and fractions obtained from natural fats and oils, for example peanut oil fatty acid, fish oil fatty acid, linseed oil fatty acid, palm oil fatty acid, rapeseed oil fatty acid, ricinoleic oil fatty acid, castor oil fatty acid, colza oil fatty acid, soya oil fatty acid, sunflower oil fatty acid, safflower oil fatty acid and tall oil fatty acid, which have appropriate iodine numbers.

Likewise suitable as fatty acids are dicarboxylic acids such as dimerized fatty acids and alkyl- and also alkenylsuccinic acids having C₈-C₅₀-alk(en)yl radicals, preferably having C₈-C₄₀-, in particular having C₁₂-C₂₋₂-alkyl radicals. The alkyl radicals can be linear or branched (oligomerized alkenes, polyisobutylene) and saturated or unsaturated. Preference is given to proportions of up to 10% by weight, in particular less than 5% by weight, based on the constituent A).

In addition, the fatty acid mixtures can contain minor amounts, i.e. up to 20% by weight, preferably less than 10% by weight, in particular less than 5% by weight and especially less than 2% by weight, of saturated fatty acids, for example lauric acid, tridecanoic acid, myristic acid, pentadecanoic acid, palmitic acid, margaric acid, stearic acid, isostearic acid, arachidic acid and behenic acid.

The fatty acids can also contain 1-40% by weight, especially 1-25% by weight, in particular 1-5% by weight, of resin acids.

Suitable alcohols contain from 1 to 5 carbon atoms. Particularly suitable alcohols are methanol and ethanol, in particular methanol.

The esters can be prepared by esterification from alcohols and fatty acids in a known manner. Preference is given to transesterifying naturally occurring fats and oils with lower alcohols and especially with methanol, resulting in the by-production of glycerol. Preference is given to those esters that can be prepared from a fatty acid mixture.

The alkylphenol-aldehyde resins (B) present in the additive according to the invention are known in principle and described, for example, in Römpp Chemie Lexikon, 9th edition, Thieme Verlag 1988-92, Volume 4, p. 3351ff. The alkyl or alkenyl radicals of the alkylphenol have 6-24, preferably 8-22, in particular 9-18, carbon atoms. They may be linear or branched, and the branch may contain secondary and also tertiary structures. They are preferably n- and isohexyl, n- and isooctyl, n- and isononyl, n- and isodecyl, n- and isododecyl, tetradecyl, hexadecyl, octadecyl, eicosyl and also tripropenyl, tetrapropenyl, pentapropenyl and polyisobutenyl up to C₂₄. The alkylphenol-aldehyde resin may also contain up to 20 mol % of phenol units and/or alkylphenols having short alkyl chains, for example butylphenol. For the alkylphenol-aldehyde resin, the same or different alkylphenols may be used.

The aldehyde in the alkylphenol-aldehyde resin has from 1 to 10, preferably from 1 to 4, carbon atoms, and may bear further functional groups. It is preferably an aliphatic aldehyde, more preferably formaldehyde.

The molecular weight of the alkylphenol-aldehyde resins is preferably 350-10 000, in particular 400-5000 g/mol. This preferably corresponds to a degree of condensation n of from 3 to 40, in particular from 4 to 20. A prerequisite is that the resins are oil-soluble.

In a preferred embodiment of the invention, these alkylphenol-formaldehyde resins are those which are oligomers or polymers having a repeating structural unit of the formula

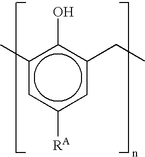

where R^{A} is C₆-C₂₄-alkyl or -alkenyl and n is a number from 2 to 50.

The alkylphenol-aldehyde resins are prepared in a known manner by basic catalysis to give condensation products of the resol type, or by acidic catalysis to give condensation products of the novolak type.

The condensates obtained in both ways are suitable for the compositions according to the invention. Preference is given to the condensation in the presence of acidic catalysts.

To prepare the alkylphenol-aldehyde resins, an alkylphenol having 6-24, preferably 8-22, in particular 9-18, carbon atoms per alkyl group, or mixtures thereof, are reacted with at least one aldehyde, using about 0.5-2 mol, preferably 0.7-1.3 mol and in particular equimolar amounts of aldehyde, per mole of alkylphenol compound.

Suitable alkylphenols are in particular n- and isohexylphenol, n- and isooctylphenol, n- and isononylphenol, n- and isodecylphenol, n- and isododecylphenol, tetradecylphenol, hexadecylphenol, octadecylphenol, eicosylphenol, tripropenylphenol, tetrapropenylphenol and poly(isobutenyl)phenol up to C₂₄.

The alkylphenols are preferably para-substituted. The alkylphenols may bear one or more alkyl radicals. The proportion substituted by more than one alkyl group is preferably at most 5 mol %, in particular at most 20 mol % and especially at most 40 mol %. At most 40 mol %, in particular at most 20 mol %, of the alkylphenols used preferably bear an alkyl radical in the ortho-position. Especially, the alkylphenols are unsubstituted by tertiary alkyl groups in the ortho-position to the hydroxyl group.

The aldehyde may be a mono- or dialdehyde and bear further functional groups such as —COOH. Particularly suitable aldehydes are formaldehyde, acetaldehyde, butyraldehyde, glutardialdehyde and glyoxalic acid, preferably formaldehyde. The formaldehyde may be used in the form of paraformaldehyde or in the form of a preferably 20-40% by weight aqueous formalin solution. It is also possible to use corresponding amounts of trioxane.

Alkylphenol is customarily reacted with aldehyde in the presence of alkaline catalysts, for example alkali metal hydroxides or alkylamines, or of acidic catalysts, for example inorganic or organic acids, such as hydrochloric acid, sulfuric acid, phosphoric acid, sulfonic acid, sulfamido acids or haloacetic acids. The condensation is preferably carried out without solvent at from 90 to 200° C., preferably at from 100 to 160° C. In a further preferred embodiment, the reaction is effected in the presence of an organic solvent which forms an azeotrope with water, for example toluene, xylene, higher aromatics or mixtures thereof. The reaction mixture is heated to a temperature of from 90 to 200° C., preferably 100-160° C., and the water of reaction formed is removed during the reaction by azeotropic distillation. Solvents which release no protons under the conditions of the condensation can remain in the products after the condensation reaction. The resins may be used directly or after neutralization of the catalyst, optionally after further dilution of the solution with aliphatic and/or aromatic hydrocarbons or hydrocarbon mixtures, for example petroleum fractions, kerosene, decane, pentadecane, toluene, xylene, ethylbenzene or solvents such as ®Solvent Naphtha, ®Shellsol AB, ®Solvesso 150, ®Solvesso 200, ®Exxsol, and ®ISOPAR and ®Shellsol D types.

The proportions by weight of the constituents A) and B) in the additives according to the invention may vary within wide limits depending on the application. They are preferably between 10 and 99.999% by weight of A) to from 90 to 0.001% by weight of B), in particular between 20 and 99.995% by weight of A) to from 80 to 0.005% by weight of B). To stabilize the fatty acid esters, preference is given to using smaller proportions of component B of from 0.001 to 20% by weight, preferably from 0.005 to 10% by weight, of B), but in contrast, to optimize the lubricity, larger proportions of B of, for example, from 5 to 90% by weight, preferably from 10 to 80% by weight and in particular from 15 to 75% by weight, are used.

It has likewise been found that, surprisingly, a further increase in effectiveness as a lubricity additive is achieved when the mixtures according to the invention are used together with nitrogen-containing paraffin dispersants. Paraffin dispersants are additives which reduce the size of the precipitating paraffin crystals on cooling of the oil and in addition prevent the paraffin particles from depositing, but instead keep them dispersed colloidally with a distinctly reduced tendency to sediment.

The paraffin dispersants are preferably low molecular weight or polymeric, oil-soluble compounds having ionic or polar groups, for example amine salts, imides and/or amides. Particularly preferred paraffin dispersants contain reaction products of secondary fatty amines having from 8 to 36 carbon atoms, in particular dicoconut fatty amine, ditallow fatty amine and distearylamine. Particularly useful paraffin dispersants have proven to be those obtained by reacting aliphatic or aromatic amines, preferably long-chain aliphatic amines, with aliphatic or aromatic mono-, di-, tri-, or tetracarboxylic acids or their anhydrides (cf. U.S. Pat. No. 4,211,534). Other paraffin dispersants are copolymers of maleic anhydride and α,β-unsaturated compounds which can optionally be reacted with primary monoalkylamines and/or aliphatic alcohols (cf. EP-A-0 154 177), the reaction products of alkenyl-spiro-bislactones with amines (cf. EP-A-0 413 279 B1) and, according to EP-A-0 606 055 A2, reaction products of terpolymers based on α,β-unsaturated dicarboxylic anhydrides, α,β-unsaturated compounds and polyoxyalkylene ethers of lower unsaturated alcohols.

Particularly preferred paraffin dispersants are prepared by reaction of compounds containing an acyl group with an amine. This amine is a compound of the formula NR⁶R⁷R⁸, in which R⁶, R⁷ and R⁸ may be identical or different, and at least one of these groups is C₈-C₃₆-alkyl, C₆-C₃₆-cycloalkyl, C₁-C₃₆-alkenyl, in particular C₁₂-C₂₄-alkyl, C₁₂-C₂₋₄-alkenyl or cyclohexyl, and the other groups are either hydrogen, C₁-C₃₆-alkyl, C₂-C₃₆-alkenyl, cyclohexyl, or a group of the formulae -(A-O)ₓ-E or —(CH₂)ₙ—NYZ, in which A is an ethylene or propylene group, x is a number from 1 to 50, E=H, C₁-C₃₀-alkyl, C₅-C₁₂-cycloalkyl or C₆-C₃₀-aryl, and n is 2, 3 or 4, and Y and Z are each independently H, C, —C₃₀-alkyl or -(A-O)ₓ. The term acyl group here is taken to mean a functional group of the following formula:

>C═O

The paraffin dispersants may be added to the additives according to the invention or added separately to the middle distillate to be additized. The ratio between paraffin dispersants and the additives according to the invention is between 5:1 and 1:5 and preferably between 3:1 and 1:3.

To prepare additive packages for specific solutions to problems, the additives according to the invention may also be used together with one or more oil-soluble coadditives which alone improve the lubricity and/or cold-flow properties of crude oils, lubricant oils or fuel oils. Examples of such coadditives are vinyl acetate-containing copolymers or terpolymers of ethylene, comb polymers and also oil-soluble amphiphiles.

For instance, mixtures of the additives according to the invention with copolymers which contain from 10 to 40% by weight of vinyl acetate and from 60 to 90% by weight of ethylene have proven outstandingly suitable. In a further embodiment of the invention, the additives according to the invention are used in a mixture with ethylene/vinyl acetate/vinyl 2-ethylhexanoate terpolymers, ethylene/vinyl acetate/vinyl neononanoate terpolymers and/or ethylene/vinyl acetate/vinyl neodecanoate terpolymers to simultaneously improve the flowability and lubricity of mineral oils or mineral oil distillates. Apart from ethylene, the terpolymers of vinyl 2-ethylhexanoates, vinyl neononanoates or vinyl neodecanoates contain from 10 to 35% by weight of vinyl acetate and from 1 to 25% by weight of the particular long-chain vinyl ester. In addition to ethylene and from 10 to 35% by weight of vinyl esters, further preferred copolymers also contain from 0.5 to 20% by weight of olefin having from 3 to 10 carbon atoms, for example isobutylene, diisobutylene, 4-methylpentene or norbornene.

Finally, in a further embodiment of the invention, the additives according to the invention are used together with comb polymers. This refers to polymers in which hydrocarbon radicals having at least 8, in particular at least 10, carbon atoms are bonded to a polymer backbone. These are preferably homopolymers whose alkyl side chains have at least 8 and in particular at least 10 carbon atoms. In copolymers, at least 20%, preferably at least 30%, of the monomers have side chains (cf. Comb-like Polymers-Structure and Properties; N. A. Platé and V. P. Shibaev, J. Polym. Sci. Macromolecular Revs. 1974, 8, 117 ff). Examples of suitable comb polymers are, for example, fumarate/vinyl acetate copolymers (cf. EP 0 153 76 A1), copolymers of a C₆-C₂₄-α-olefin and an N—C₆-C₂₂-alkylmaleimide (cf. EP-A-0 320 766), and also esterified olefin/maleic anhydride copolymers, polymers and copolymers of α-olefins and esterified copolymers of styrene and maleic anhydride.

Comb polymers can be described, for example, by the formula

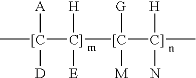

In this formula:

A is R′, COOR′, OCOR′, R″—COOR′ or OR′;

D is H, CH₃, A or R;

E is H or A;

G is H, R″, R″—COOR′, an aryl radical or a heterocyclic radical;

M is H, COOR″, OCOR″, OR″ or COOH;

N is H, R″, COOR″, OCOR, COOH or an aryl radical;

R′ is a hydrocarbon chain having 8-150 carbon atoms;

R″ is a hydrocarbon chain having from 1 to 10 carbon atoms;

m is a number between 0.4 and 1.0; and

n is a number between 0 and 0.6.

The mixing ratio (in parts by weight) of the additives according to the invention with ethylene copolymers or comb polymers is in each case from 1:10 to 20:1, preferably from 1:1 to 10:1.

The oily liquids according to the invention are suitable in particular for use as fuel oil in diesel engines.

The oily liquids according to the invention are added to oils as additives in amounts of from 0.001 to 10% by weight, preferably from 0.01 to 5% by weight and especially from 0.02 to 2% by weight. They may be used as such or else dissolved in solvents, for example aliphatic and/or aromatic hydrocarbons or hydrocarbon mixtures, for example toluene, xylene, ethylbenzene, decane, pentadecane, petroleum fractions, diesel, kerosene or commercial solvent mixtures such as Solvent Naphtha, ®Shellsol AB, ®Solvesso 150, ®Solvesso 200, ®Exxsol, and ®Isopar and ®Shellsol D types, and also polar solvents such as alcohols, glycols and esters. The additives according to the invention preferably contain up to 70%, especially 5-60%, in particular 10-40% by weight, of solvent. Particular preference is given to using them without adding further solvents.

The oily liquids according to the invention can be stored without aging effects at elevated temperature over a long period, without any symptoms of aging occurring, such as resinification and the formation of insoluble structures or deposits in storage containers and/or engine parts. In addition, they improve the oxidation stability of the oils additized with them. This is advantageous in particular in oils which contain relatively large fractions of oils from cracking processes.

In addition, they exhibit an improvement in lubricity of middle distillates superior to the individual components. This allows the dosage required for the setting of the specification to be reduced.

A further advantage of the oily liquids according to the invention is their reduced crystallization temperature compared to the fatty acid esters used as lubricity additives in the prior art. For instance, they can also be used at low temperatures of, for example, from 0° C. to −20° C. and sometimes even lower without any problem.

The oily liquids according to the invention are particularly well suited to use as additives in middle distillates. Middle distillates refer in particular to those mineral oils which are obtained by distillation of crude oil and boil in the range from 120 to 450° C., for example kerosene, jet fuel, diesel and heating oil. The oils can also contain alcohols such as methanol and/or ethanol or consist of these. The additives according to the invention are preferably used in those middle distillates which contain fewer than 350 ppm of sulfur, in particular fewer than 200 ppm of sulfur and in special cases fewer than 50 ppm or fewer than 10 ppm, of sulfur. These are generally those middle distillates which have been subjected to refining under hydrogenating conditions, and therefore only contain small fractions of polyaromatic and polar compounds which confer a natural lubricity on them. The additives according to the invention are also preferably used in those middle distillates which have 95% distillation points below 370° C., in particular 350° C. and in special cases below 330° C. The additives according to the invention are equally suitable for use in synthetic fuels likewise having low lubricity, for example as produced in the Fischer-Tropsch process. The oils having improved lubricity have a Wear Scar Diameter measured in the HFRR test of preferably less than 460 μm, especially less than 450 μm. The oily liquids according to the invention can also be used as components in lubricant oils.

The oily liquids can be used alone or else together with other additives, for example with pour point depressants, corrosion inhibitors, antioxidants, sludge inhibitors, dehazers, conductivity improvers, lubricity additives, and additives for reducing the cloud point. They are also used successfully together with additive packages which contain, inter alia, known ashless dispersing additives, detergents, antifoams, antioxidants, dehazers, demulsifiers and corrosion inhibitors.

The advantages of the oily liquids according to the invention are illustrated in detail by the examples which follow.

### EXAMPLES

The constituents of the oily liquids used are characterized hereinbelow. Iodine numbers are determined according to Kaufmann. In this method, the sample is admixed with a defined amount of a methanolic bromine solution, which results in an amount of bromine equivalent to the content of double bonds adding onto them. The excess of bromine is back-titrated using sodium thiosulfate.

TABLE 1
Characterization of the fatty acid esters used

| | | Iodine |
|---|---|---|
| | | number |
| Example | Chemical description | [gl/100 g] |
| A1 | Rapeseed oil methylester containing, as the main | 123 |
| | components, 45% of oleic acid, 39% of linoleic | |
| | acid, 4.5% of linolenic acid | |
| A2 | Soya oil methylester containing, as the main | 134 |
| | components, 25% of oleic acid, 51% of linoleic | |
| | acid, 7% of linolenic acid | |
| A3 | Tallow fatty acid methylester containing, as | 102 |
| | the main components, 65% of oleic acid, | |
| | 18% of linolenic acid | |

TABLE 2
Characterization of the alkylphenol resins used

| | |
|---|---|
| B1 | C₂₀-C₂₄-alkylphenol-formaldehyde resin, prepared by condensing a |
| | mixture of C₂₀-C₂₄-alkylphenol having 35 mol % of di-(C₂₀-C₂₄- |
| | alkyl)phenol with formaldehyde, Mw 2500 g/mol; 50% in Solvent |
| | Naphtha |
| B2 | Dodecylphenol-formaldehyde resin, prepared by condensing a |
| | mixture of dodecylphenol having 1.3 mol % of didodecylphenol |
| | with Mw formaldehyde, MW 2200 g/mol; 50% in Solvent Naphtha |
| B3 | Nonylphenol-formaldehyde resin, prepared by condensing a mixture |
| | of nonylphenol having 0.5 mol % of dinonylphenol with |
| | formaldehyde, Mw 2000 g/mol; 50% in Solvent Naphtha |

Oxidation Stability of the Additives

10 g of the fatty acid mixture to be tested and the amount of resin specified in Table 3 are weighed into a 500 ml Erlenmeyer flask. The flask is stored in a drying cabinet at a temperature of 90° C. for three days, and the atmosphere above the additive is changed daily by passing over an air stream.

After the conditioning, the mixture is allowed to cool to room temperature for one hour. Subsequently, the mixture is admixed with 500 ml of diesel fuel (test oil 1) and mixed thoroughly. After standing for a period of two hours, the mixture is visually examined for any deposits, cloudiness, insoluble fractions, etc., which give indications of oxidative changes (visual examination). The mixture is then filtered through a 0.8 μm filter at a pressure differential of 800 mbar. The entire amount has to be filterable within 2 minutes, otherwise the volume which has been filtered after 2 minutes is noted.

TABLE 3
Oxidation stability

| Example | A | B | Visual examination | Filtration |
|---|---|---|---|---|
| 1 (comp.) | — | — | clear | 34 s |
| 2 (comp.) | 10 g A1 | — | cloudy + insoluble resin | 120 s/210 ml |
| 3 (comp.) | 10 g A2 | — | cloudy + insoluble resin | 120 s/330 ml |
| 4 (comp.) | 10 g A3 | — | cloudy + insoluble resin | 120 s/470 ml |
| 5 | 10 g A1 | 0.5 g B3 | homogenously cloudy | 79 s |
| 6 | 10 g A1 | 1 g B3 | almost clear | 52 s |
| 7 | 10 g A1 | 2 g B3 | clear | 46 s |
| 8 | 10 g A1 | 0.5 g B1 | clear | 45 s |
| 9 | 10 g A1 | 2 g B1 | clear | 43 s |
| 10 | 10 g A1 | 1 g B2 | clear | 47 s |
| 11 | 10 g A1 | 2 g B2 | clear | 43 s |
| 12 | 10 g A2 | 1 g B1 | clear | 39 s |
| 13 | 10 g A2 | 1 g B3 | clear | 37 s |
| 14 | 10 g A2 | 0.1 g B3 | clear | 42 s |
| 15 | 10 g A3 | 1 g B3 | clear | 40 s |

n.a. = not applicable, since not completely soluble

Lubricity in Middle Distillates

The lubricity of the additives was tested on additized oils at 60° C. by means of an HFRR instrument from PCS Instruments. The high frequency reciprocating rig test (HFRR) is described in D. Wei, H. Spikes, Wear, Vol. 111, No. 2, p. 217, 1986. The results are quoted as friction coefficient and wear scar (WS 1.4). A low wear scar and a low coefficient of friction indicate good lubricity. Wear scar values of less than 460 μm are regarded as an indication of sufficient lubricity, although values of less than 400 μm are sought in practice. The dosages in Table 6 relate to the amount of added active ingredient.

TABLE 4
Characterization of the test oils used

| | | Test oil 1 | Test oil 2 |
|---|---|---|---|
| Distillation | | | |
| IBP | [° C.] | 171 | 164 |
| 20% | [° C.] | 218 | 214 |
| 90% | [° C.] | 323 | 342 |
| FBP | [° C.] | 352 | 367 |
| Cloud Point | [° C.] | −8.2 | −7.7 |
| CFPP | [° C.] | −12 | −13 |
| Density @ 15° C. | [g/cm³] | 0.8262 | 0.8293 |
| Sulfur | [ppm] | 15 | 195 |

TABLE 5
Characterization of the polar nitrogen-
containing compounds used

| | |
|---|---|
| C1 | Reaction product of a dodecenyl-spiro-bislactone with a mixture of primary and |
| | secondary tallow fatty amine, 60% in Solvent Naphtha (prepared according to EP-A- |
| | 0413279) |
| C2 | Reaction product of a terpolymer of a C14/16-α-olefin, maleic anhydride and allyl |
| | polyglycol with 2 equivalents of ditallow fatty amine, 50% in Solvent Naphtha (prepared |
| | according to EP-A-0606055) |
| C3 | Reaction product of phthalic anhydride and 2 equivalents of di(hydrogenated tallow |
| | fatty) amine, 50% in Solvent Naphtha (prepared according to EP-A-0061894) |
| C4 | Reaction product of ethylenediaminetetraacetic acid with 4 equivalents of ditallow fatty |
| | amine to give the amide-ammonium salt (prepared according to EP-A-03981 01) |

TABLE 6
Wear scar in test oil 1

| | | | | Wear | |
|---|---|---|---|---|---|
| Example | Dosage of A | Dosage of B | Dosage of C | scar | Friction |
| 16 (comp.) | — | 13 | — | 575 | 0.329 |
| 17 | 0.2% A1 | — | — | 537 | 0.260 |
| 18 | 0.5% A1 | — | — | 498 | 0.205 |
| 19 | 0.75% A1 | — | — | 423 | 0.180 |
| 20 | 1.0% A1 | — | — | 373 | 0.171 |
| 21 (comp.) | — | 0.025% B1 | — | 555 | 0.312 |
| 22 (comp.) | — | 0.05% B1 | — | 467 | 0.201 |
| 23 | 0.5% A1 | 0.05% B1 | — | 387 | 0.178 |
| 24 | 0.4% A1 | 0.02% B1 | | 448 | 0.195 |
| 25 | 0.3% A1 | 0.03% B1 | — | 408 | 0.178 |
| 26 (comp.) | — | 0.05% B3 | — | 565 | 0.320 |
| 27 (comp.) | — | 0.1% B3 | — | 510 | 0.243 |
| 28 | 0.5% A1 | 0.05% B3 | — | 382 | 0.180 |
| 29 | 0.5% A1 | 0.1% B3 | — | 303 | 0.174 |
| 30 | 0.3% A1 | 0.075% B3 | — | 432 | 0.181 |
| 31 | 0.3% A2 | — | — | 523 | 0.248 |
| 32 | 0.3% A2 | 0.03% B1 | — | 376 | 0.182 |
| 33 | 0.3% A2 | 0.03% B2 | — | 391 | 0.185 |
| 34 | 0.25% A2 | 0.02% B1 | 0.01% Cl | 371 | 0.178 |
| 35 | 0.25% A2 | 0.02% B1 | 0.01% C2 | 343 | 0.176 |
| 36 | 0.25% A2 | 0.02% B1 | 0.01% C3 | 365 | 0.177 |
| 37 | 0.25% A2 | 0.02% B1 | 0.01% C4 | 358 | 0.178 |

TABLE 7
Wear scar in test oil 2

| | | | | Wear | |
|---|---|---|---|---|---|
| Example | Dosage of A | Dosage of B | Dosage of C | scar | Friction |
| 38 (comp.) | — | — | — | 540 | 0.266 |
| 39 (comp.) | 0.2% A2 | — | — | 502 | 0.240 |
| 40 (comp.) | 0.4% A2 | — | — | 435 | 0.207 |
| 41 (comp.) | 0.6% A2 | — | — | 386 | 0.177 |
| 42 (comp.) | — | 200 ppm B2 | — | 535 | 0.255 |
| 43 (comp.) | — | 400 ppm B2 | — | 502 | 0.235 |
| 44 | 0.5% A2 | 200 ppm B2 | — | 275 | 0.166 |
| 45 | 0.4% A2 | 300 ppm 82 | — | 375 | 0.174 |
| 46 | 0.3% A2 | 150 ppm B2 | 100 ppm C1 | 398 | 0.187 |
| 47 | 0.25% A2 | 150 ppm B2 | 100 ppm C2 | 403 | 0.188 |

What is claimed is:

1. An oily liquid, comprising
A) at least one ester of fatty acids whose carbon chain lengths are between 8 and 30 carbon atoms, and a monohydric C₁-C₅-alcohol, at least 50% of the fatty acid radicals containing at least one double bond, and
B) at least one alkylphenol-aldehyde resin, obtainable by condensing
(i) at least one alkylphenol having at least one C₆-C₂₄-alkyl or C₆-C₂₄-alkenyl radical and
(ii) at least one aldehyde or ketone
to a degree of condensation of between 2 and 50 alkylphenol units.

2. A composition as claimed in claim 1, wherein the iodine number of constituent A) is more than 50 g of 1/100 g of ester.

3. A composition as claimed in one or more of claims 1 to 2, wherein the fatty acids which are a constituent of component A) contain from 10 to 26 carbon atoms.

4. A composition as claimed in one or more of claims 1 to 3, wherein the fatty acid esters A) contain at least 75% by weight of fatty acids having one or more double bonds.

5. A composition as claimed in one or more of claims 1 to 4, wherein the fatty acid mixtures contain one or more dicarboxylic acids.

6. A composition as claimed in one or more of claims 1 to 5, wherein the alcohols from which constituent A) is derived are methanol or ethanol.

7. A composition as claimed in one or more of claims 1 to 6, wherein constituent A) is derived from fatty acid mixtures which comprise up to 20% by weight of saturated fatty acids.

8. A composition as claimed in one or more of claims 1 to 7, which also comprises at least one nitrogen-containing paraffin dispersant.

9. A composition as claimed in one or more of claims 1 to 8, which also comprises at least one ethylene copolymer.

10. A composition as claimed in one or more of claims 1 to 9, which also comprises at least one comb polymer.

11. A fuel oil having a maximum sulfur content of 0.035% by weight, comprising a composition as claimed in one or more of claims 1 to 10 in amounts of from 0.001 to 0.5% by weight, based on the fuel oil.

12. The use of a composition as claimed in one or more of claims 1 to 10 in amounts of from 0.001 to 0.5% by weight, based on the fuel oil, for improving the lubricity of fuel oils having a sulfur content of at most 0.035% by weight.
